(19) United States
(12) Patent Application Publication
(10) Pub. No.: US 2002/0139965 A1
(43) Pub. Date: Oct. 3, 2002

(54) Automotive differential removal and installation tool

(76) Inventor: John Brackett, Wilmington, MA (US)

Correspondence Address: John Brackett, 445 Shawsheen Avenue, Wilmington, MA, 01887-1635, US

(21) Appl. No.: 09/820,601

(22) Filed: Mar. 30, 2001

(51) Int. Cl. B66F 3/00

(52) U.S. Cl. 254/134

(57) ABSTRACT

An efficient and competitively priced tool to be used in the automotive industry is provided. The objective is achieved by combining the invention with a standard automotive floor or trolley jack in the removal and installation of an automobile's removable carrier differential, as found specifically in Ford 9-inch rear axles. The invention is a major improvement over all prior art in its field.

### CROSS REFERENCE TO RELATED APPLICATIONS

Not Applicable

### STATEMENT REGARDING FEDERALLY SPONSORED RESEARCH AND DEVELOPMENT

Not Applicable

### REFERENCE TO A MICROFICHE APPENDIX

Not Applicable

### BACKGROUND OF THE INVENTION

In the automotive repair, racing and after-market industries removing and replacing the differential in the type of rear axle with a removable carrier differential has long been considered difficult. Differentials are odd shaped and weigh approximately 75 pounds. This task is presently performed in one of two methods. The first method is by hand and is an extremely cumbersome and somewhat dangerous operation. The second method is by the use of an adapter, made to mount on a standard floor or trolley jack. That tool is similar in concept to the invention provided but is unstable in use. It consists solely of four prongs. (See the Information Disclosure Statement). It does not contain the differential positively but instead allows it to roll side to side and front to back. Differentials have been known to fall off of these type apparatuses.

### BRIEF SUMMARY OF THE INVENTION

The provided invention positively fastens to and supports the differential. It is also adjustable to allow for variations in jacked height of the vehicle and variations of the pinion angle of the rear axle.

### BRIEF DESCRIPTION OF THE DRAWING

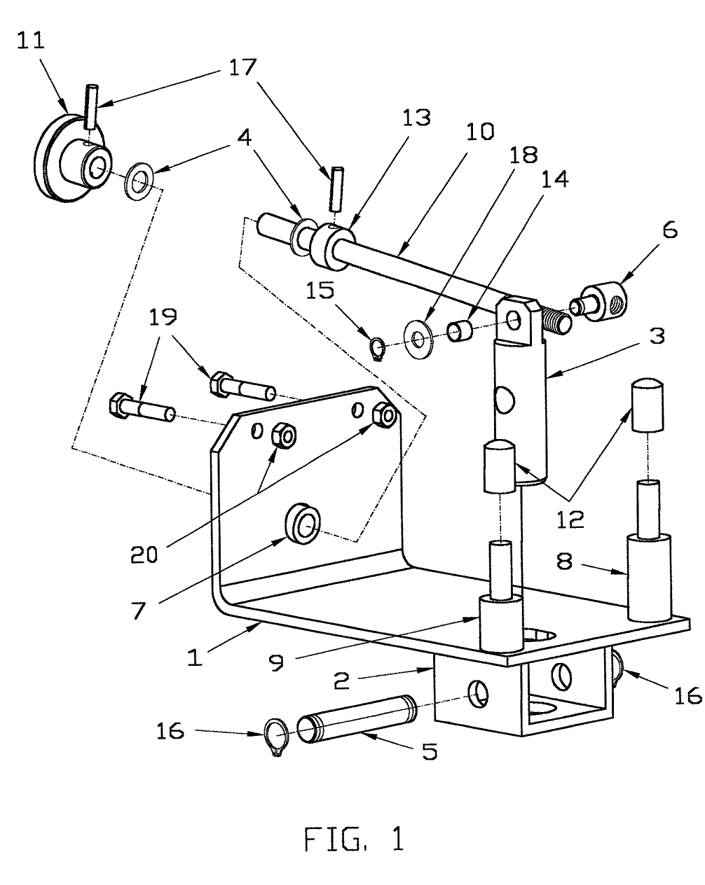

1. FIG. 1 is a three-dimensional exploded assembly view of the invention.

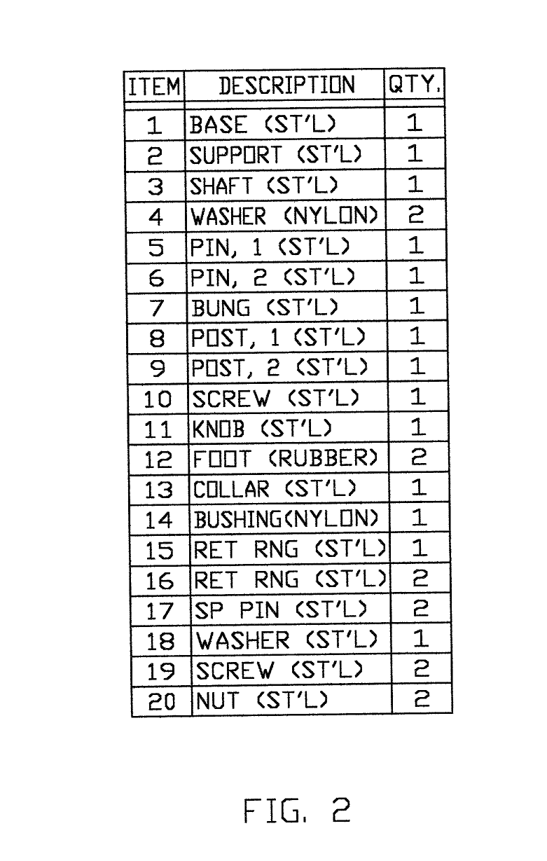

2. FIG. 2 is a parts list for the assembly FIG. 1.

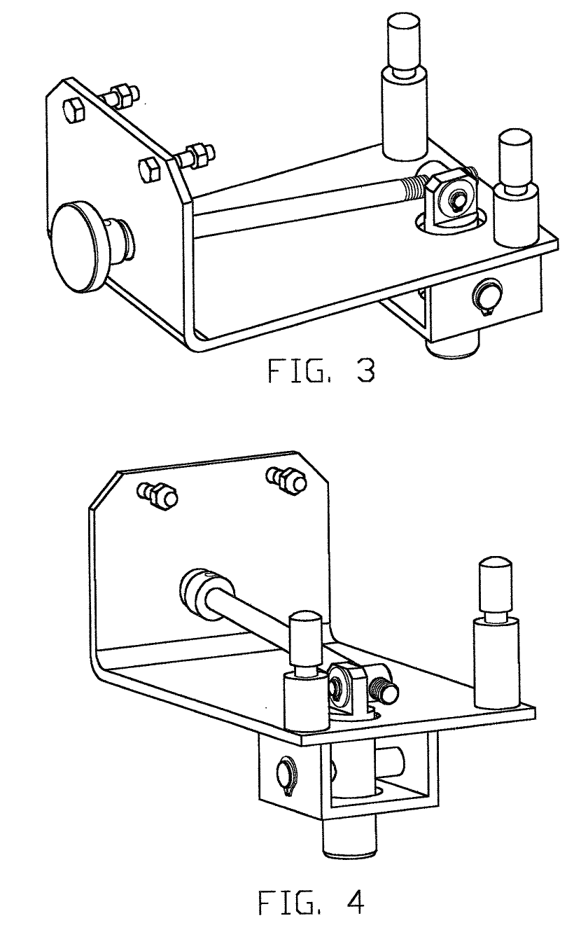

3. FIG. 3 and 4 are three-dimensional views of the invention

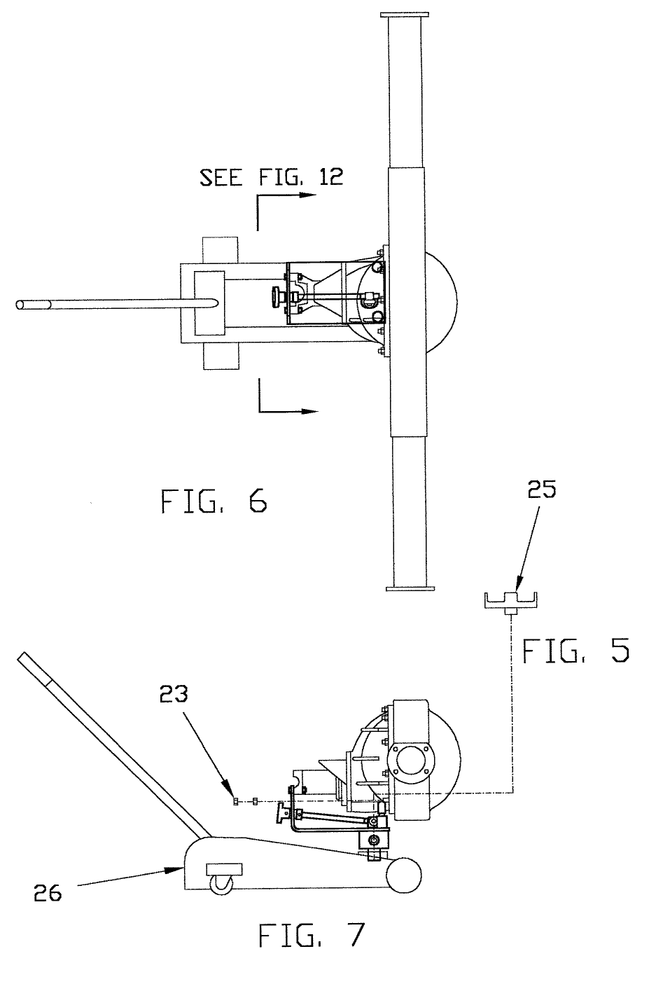

4. FIG. 5 is an elevation view of the saddle 25 removed from the jack 26.

5. FIG. 6 is a plan view and FIG. 7 is an elevation view that show the invention mounted in the jack and bolted to the differential prior to removal of the differential from the rear axle.

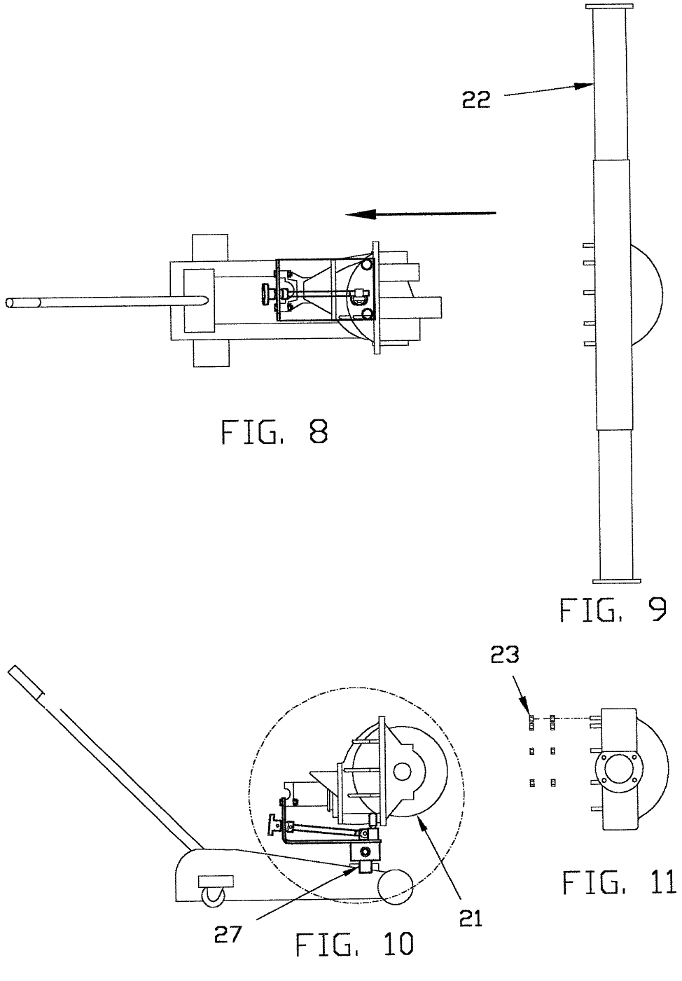

6. FIG. 8 and 9 are plan views and FIG. 10 and 11 are elevation views, all shown after the differential has been removed from the rear axle.

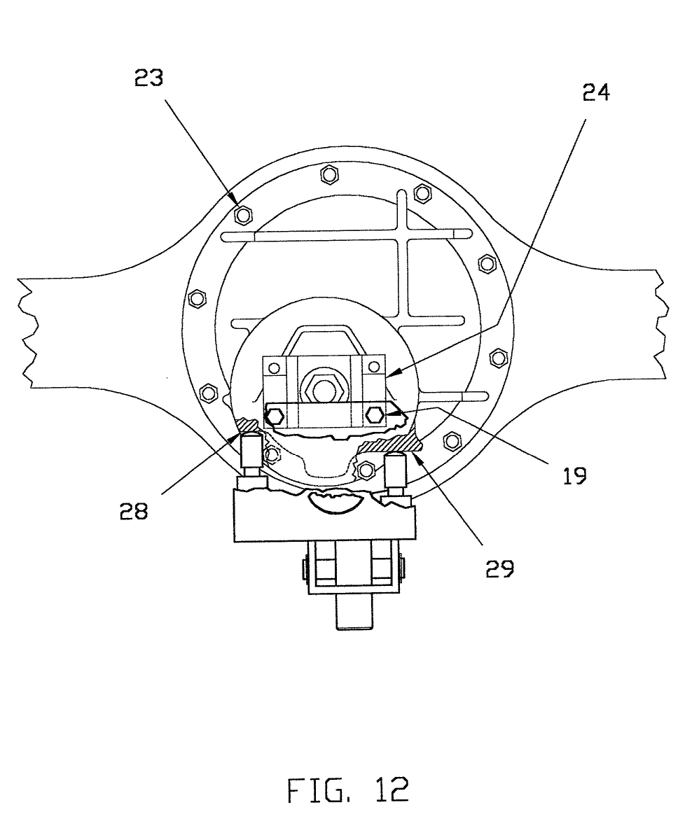

7. FIG. 12 is an enlarged partial view rotated 90 degrees counter-clockwise of FIG.6.

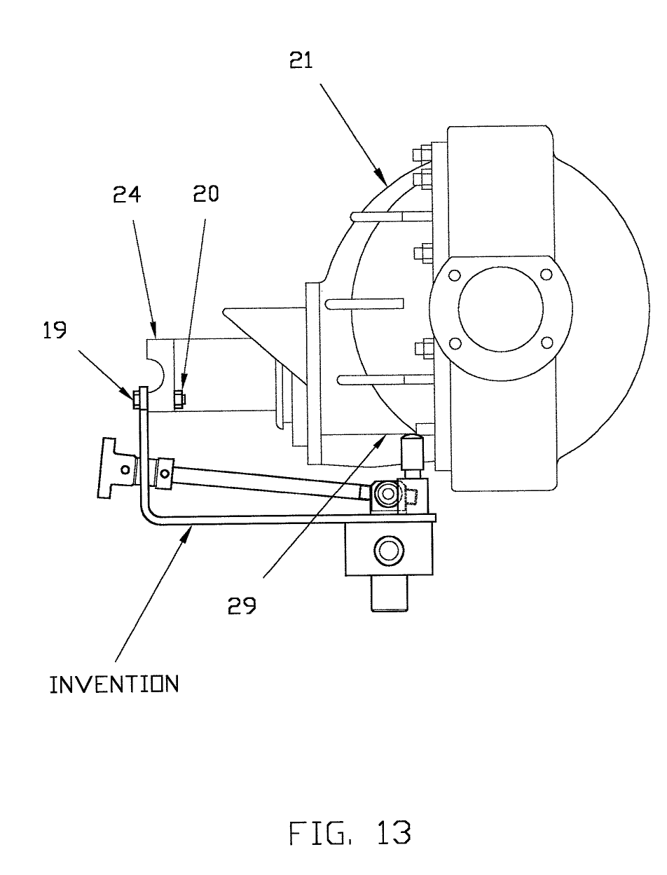

8. FIG. 13 is an enlarged partial view of FIG. 10.

### DETAILED DESCRIPTION OF THE INVENTION

### Manufacture of the Invention

1. Parts 1, 2, 7, 8, 9 are joined by welding.

2. Parts 11 and 13 are assembled to part 10 by drilling and installing part 17.

3. The remaining parts 3, 4, 5, 6, 12, 14, 15, 16, 18, 19, 20 are assembled as shown.

### Process of using Invention

1. After jacking the vehicle and removing the driveshaft loosen the ten retaining nuts 23 that fasten the differential 21 to the rear axle 22 enough to allow the oil to drain.

2. Remove the two nuts located at the bottom of the nut array.

3. Attach the invention to the differential's pinion flange 24 using the screws 19 and nuts 20, making sure the two posts 8, 9 of the invention sit under the flat areas 28, 29, one on each side, of the differential.

4. Remove the saddle 25 from the jack 26 and roll and pump the jack until the shaft 3 of the invention is into or near the saddle mounting hole 27.

5. Adjustment of the invention may be necessary to allow the shaft of the invention to slide into the saddle mounting hole. Adjustment is accomplished by rotating the knob 11 clockwise or counter-clockwise to attain a 10 degree tilt in either direction.

6. When the shaft is in the saddle hole remove the remaining eight retainings nuts 23.

7. Pump the jack slightly to elevate it and free the differential from the rear axle and remove it from the automobile.

8. To install the differential reverse the above procedure.

### Improvement Invented

The invention uses two 5/16 screws 19 and two nuts 20 to bolt it to the front face of the pinion flange. There are four holes in the pinion flange that are exposed after removal of the driveshaft. The two lower holes are utilized to mount the invention. Upon installing the screws and nuts the posts 8, 9 of the invention come to rest upon two corresponding flat areas 28, 29, one on each side, of the differential. No prior art fastens and supports the differential in as positive a configuration.

1. I claim my invention is unique in both the manner in which it positively fastens to and positively supports an automotive differential during removal and installation of same, thereby exhibiting strong marketability, especially in the automotive racing industry where the 9-inch ford differential is employed in nearly all race cars:
